(19) United States
(12) Patent Application Publication
(10) Pub. No.: US 2009/0051991 A1
(43) Pub. Date: Feb. 26, 2009

(54) OPTICAL BEAM SCANNING APPARATUS AND IMAGE FORMING APPARATUS

(75) Inventor: Yasushi KURIBAYASHI, Shizuoka-Ken (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/191,231

(22) Filed: Aug. 13, 2008

Related U.S. Application Data
(60) Provisional application No. 60/957,692, filed on Aug. 23, 2007.

(51) Int. Cl. G02B 26/10

(52) U.S. Cl. 359/197

(57) ABSTRACT

An optical beam scanning beam apparatus includes: a light source that emits one or more light fluxes; an optical beam deflecting device that deflects the light flux, which is emitted from the light source, to an scanned object in a main scanning direction; and an aperture part provided between the light source and the optical beam deflecting device. The aperture part includes a first aperture through which a main light beam of the light flux emitted from the light source passes, and at least one second aperture which is different from the first aperture and is provided at one or more of both sides or one side in the main scanning direction and a sub-scanning direction of the first aperture. With this configuration, it is possible to properly reduce sidelobe occurring in a beam profile.

### BACKGROUND OF THE INVENTION

1. Technical Field of the Invention

The present invention relates to an optical beam scanning apparatus and an image forming apparatus equipped with the optical beam scanning apparatus, and more particularly, to an optical beam scanning apparatus which is capable of reducing a sidelobe occurring in a beam profile, and an image forming apparatus equipped with the optical beam scanning apparatus.

2. Description of the Related Art

Image forming apparatuses employing an electrophotographic method, such as a laser printer, a digital copying machine, a laser facsimile machine and so on, each have an optical beam scanning apparatus for forming an electrostatic latent image on a photoconductive drum by irradiating and scanning a surface of the photoconductive drum with a laser beam (light beam).

In recent years, a tandem color apparatus has been proposed in addition to a monochrome apparatus equipped with a scanning optical system using a single light source, and in addition, a method for use in the tandem color apparatus has been proposed, which increases the number of laser beams to be scanned one time using a plurality of light sources (laser diodes) arranged in a single laser unit for the purpose of increasing the scan speed on a surface of a photoconductive drum (multi-beam method). In the multi-beam method, a plurality of beams for each of color components (for example, yellow, magenta, cyan and black) emitted from each light source are processed to be combined into a single integrated beam in a pre-deflection optical system, and then the single integrated beam is incident on a polygon mirror. The polygon mirror deflects the incident beam which in turn passes through an fθ lens constituting a post-deflection optical system to be separated into beams for respective color components to be irradiated on respective photoconductive drums corresponding to the respective color components.

In general, between a semiconductor laser device as a light source and a polygon mirror is arranged a diaphragm (aperture) to allow a laser beam, which passed through a finite focus lens (collimator lens), to have any beam sectional shape. When laser light (laser beam) having a uniform energy distribution passes through a rectangular aperture of the diaphragm (aperture part), a beam profile at an image plane on which an image is formed by an imaging optical system may have a sidelobe occurring in a main scanning direction and a sub-scanning direction (directions perpendicular to each side of the rectangular aperture).

In the related art, JP-A-2005-266258 discloses a technique of suppressing a height of a sidelobe (flare) by diversifying directions of the sidelobe (flare) occurring in a beam profile using a polygonal or circular aperture provided in a diaphragm.

In addition, JP-A-2004-191929 discloses a technique in which a partial light shielding member for shielding only a luminous flux of a laser beam which passes an annular region which is separated by a predetermined distance in the radial direction from the center axis of the beam with a light shielding part is arranged on an optical path of the laser beam between a laser light source and a polygon mirror.

In addition, the following techniques have been known as techniques related to techniques for reducing the sidelobe.

JP-A-2004-279632 discloses a technique in which apertures other than apertures through which a laser beam passes of a plurality of apertures are blocked so that the laser beam can not pass therethrough, thereby alleviating image defects such as a dark stripe and the like which may occur when flare light of the laser beam emerges from the apertures and reaches a photoconductor.

JP-A-10-208273 discloses a technique in which an aperture diaphragm has a light transmitting part to allow a light beam to be irradiated on an annular section of a thin flange of an object lens from a recording medium side, and is formed with three concentric through holes with an equiangular interval.

JP-A-2003-255254 discloses a technique in which a shape of an aperture for passing only a light beam, which contributes to formation of an image, is modified such that a first flare light beam other than a main light beam is shielded by a light shielding plate.

JP-A-11-218702 discloses a technique in which an aperture of an aperture plate is shaped so that width in a direction vertical to the scanning direction between both end portions of the aperture in the scanning direction is longer than that of the center portion in the scanning direction, thereby improving unevenness in the distribution of light quantity on a record medium.

However, in the technique disclosed in JP-A-2005-266258, although this technique reduces the amount (height) of flare by diversifying directions of occurrence of flare, since the amount of integration in the main scanning direction presents an effect in the scanning optical system, a flare diversified in a non-scanning direction is likely to have an adverse effect.

In addition, in the technique disclosed in JP-A-2004-191929, the incident luminous flux is partially shielded by the light shielding member and then is further shielded by an aperture diaphragm. However, since a shape of a laser beam intensity distribution or a height of a sidelobe on an image plane greatly depends on a positional relationship between the partial light shielding member and the aperture diaphragm and the partial light shielding member is a member different from the aperture diaphragm, the height of the sidelobe is significantly affected by an error of positioning.

Like this, there arises a problem of insufficient reduction of a sidelobe (or its height) occurring in a beam profile on an image plane when an image is formed on the image plane by an imaging optical system.

### SUMMARY OF THE INVENTION

In light of the above circumstances, it is an object of the present invention to provide an optical beam scanning apparatus which is adaptable for reducing a sidelobe occurring in a beam profile, and an image forming apparatus equipped with the optical beam scanning apparatus.

To achieve the above object, according to an aspect of the invention, there is provided an optical beam scanning beam apparatus including: a light source configured to emit one or plural light fluxes; an optical beam deflecting device configured to deflect the light flux, which is emitted from the light source, to an scanned object in a main scanning direction; and an aperture part provided between the light source and the optical beam deflecting device, the aperture part including a first aperture through which a main light beam of the light flux emitted from the light source passes, and at least one second aperture which is different from the first aperture and is provided at outer circumference of the first aperture and through which a part of the flux passes.

According to another aspect of the invention, there is provided an optical beam scanning apparatus including: a light source configured to emit one or plural light fluxes; an optical beam deflecting device configured to deflect the light flux, which is emitted from the light source, to an scanned object in a main scanning direction; and an aperture part provided between the light source and the optical beam deflecting device, the aperture part including an aperture through which a main light beam of the light flux emitted from the light source passes, a first light shielding wall forming the aperture, and a second light shielding wall to cover a portion of the aperture from a part of outer circumference of the first aperture to the center of the aperture.

According to still another aspect of the invention, there is provided an optical beam scanning apparatus including: a light source configured to emit one or plural light fluxes; an optical beam deflecting device configured to deflect the light flux, which is emitted from the light source, to an scanned object in a main scanning direction; and an aperture part provided between the light source and the optical beam deflecting device, the aperture part including a first aperture through which a main light beam of the light flux emitted from the light source passes, a first light shielding wall forming the first aperture, and a second light shielding wall to cover a portion of the first aperture in about the center of the first aperture.

According to still another aspect of the invention, there is provided an optical beam scanning apparatus including: a light source configured to emit one or plural light fluxes; an optical beam deflecting device configured to deflect the light flux, which is emitted from the light source, to an scanned object in a main scanning direction; and an aperture part provided between the light source and the optical beam deflecting device, the aperture part including an aperture through which a main light beam of the light flux emitted from the light source passes, and the light being blocked in a portion of about the center of parallel flat glass, in a portion of about the center of a cylinder lens, or in a portion of about the center of a collimator lens, which is provided in position corresponding to about the center of the aperture.

According to still another aspect of the invention, there is provided an image forming apparatus having an optical beam scanning apparatus, the optical beam scanning apparatus including: a light source configured to emit one or plural light fluxes; an optical beam deflecting device configured to deflect the light flux, which is emitted from the light source, to an scanned object in a main scanning direction; and an aperture part provided between the light source and the optical beam deflecting device, the aperture part including a first aperture through which a main light beam of the light flux emitted from the light source passes, and at least one second aperture which is different from the first aperture and is provided at outer circumference of the first aperture and through which a part of the light flux passes.

According to still another aspect of the invention, there is provided an image forming apparatus having an optical beam scanning apparatus, the optical beam scanning apparatus including: a light source configured to emit one or more light fluxes; an optical beam deflecting device configured to deflect the light flux, which is emitted from the light source, to an scanned object in a main scanning direction; and an aperture part provided between the light source and the optical beam deflecting device, the aperture part including an aperture through which a main light beam of the light flux emitted from the light source passes, a first light shielding wall forming the aperture, and a second light shielding wall to cover a portion of the aperture from a part of outer circumference of the first aperture to the center of the aperture.

According to still another aspect of the invention, there is provided an image forming apparatus having an optical beam scanning apparatus, the optical beam scanning apparatus including: a light source configured to emit one or more light fluxes; an optical beam deflecting device configured to deflect the light flux, which is emitted from the light source, to an scanned object in a main scanning direction; and an aperture part provided between the light source and the optical beam deflecting device, the aperture part including a first aperture through which a main light beam of the light flux emitted from the light source passes, a first light shielding wall forming the first aperture, and a second light shielding wall to cover a portion of the first aperture in about the center of the first aperture.

According to still another aspect of the invention, there is provided an image forming apparatus having an optical beam scanning apparatus, the optical beam scanning apparatus including: a light source configured to emit one or more light fluxes; an optical beam deflecting device configured to deflect the light flux, which is emitted from the light source, to an scanned object in a main scanning direction; and an aperture part provided between the light source and the optical beam deflecting device, the aperture part including an aperture through which a main light beam of the light flux emitted from the light source passes, and the light being blocked in a portion of about the center of parallel flat glass, in a portion of about the center of a cylinder lens, or in a portion of about the center of a collimator lens, which is provided in position corresponding to about the center of the aperture.

### BRIEF DESCRIPTION OF THE DRAWINGS

FIG. 1 is a view showing a configuration of an image forming apparatus equipped with an optical beam scanning apparatus to which the present invention is applied.

FIG. 2 is a view showing a detailed configuration of the optical beam scanning apparatus shown in FIG. 1.

FIG. 3 is a view showing a detailed configuration of the optical beam scanning apparatus shown in FIG. 1.

FIG. 4 is a view showing a sidelobe occurring in a main scanning direction and a sub-scanning direction.

FIGS. 5A to 5H are views showing a shape of an aperture of a diaphragm for reducing a sidelobe occurring in a beam profile.

FIGS. 6A to 6D are views showing an amplitude distribution or an intensity distribution in an aperture P provided in the diaphragm of FIG. 5A.

FIGS. 7A to 7D are views showing an amplitude distribution or an intensity distribution in apertures Q₁ and Q₂ provided in the diaphragm of FIG. 5A.

FIGS. 8A to 8D are views showing an amplitude distribution or an intensity distribution when the diaphragm of FIG. 5A is used.

FIG. 9 is an explanatory view for explaining a relationship between parameters of the aperture provided in the diaphragm of FIG. 5A.

FIG. 10 is a graph showing a relationship between parameters q′ and r′.

FIGS. 11A to 11F are views showing change of a beam profile when q′ is set to be between 0.01 and 0.200 for r′=0.2.

FIGS. 12A to 12D are views showing change of a beam profile when q′ is set to be between 0.250 and 0.35 for r′=0.2.

FIGS. 13A and 13B are views showing an effect in an actual scanning optical system when the diaphragm of FIG. 5A is used.

FIGS. 14A and 14B are views showing an effect in an actual scanning optical system when the diaphragm of FIG. 5A is used.

FIG. 15 is a view showing an effect in an actual scanning optical system when the diaphragm of FIG. 5A is used.

FIGS. 16A to 16C are views showing a shape of an aperture of another diaphragm for reducing a sidelobe occurring in a beam profile.

FIGS. 17A to 17C are views showing an amplitude distribution in the main scanning direction (B) and the sub-scanning direction (C) in an aperture P provided in the diaphragm of FIG. 16A.

FIGS. 18A to 18C are views showing an amplitude distribution in the main scanning direction (B) and the sub-scanning direction (C) in an aperture corresponding to a light shielding wall provided in the diaphragm of FIG. 16A.

FIGS. 19A to 19D are views showing an amplitude distribution in the main scanning direction (A) and the sub-scanning direction (B) or an intensity distribution in the main scanning direction (C) and the sub-scanning direction (D) when the diaphragm of FIG. 16A is used.

FIGS. 20A to 20C are views showing a shape of an aperture of still another diaphragm for reducing a sidelobe occurring in a beam profile.

FIGS. 21A to 21C are views showing an amplitude distribution in the main scanning direction (B) and the sub-scanning direction (C) in a rectangular aperture which constitutes an aperture provided in the diaphragm of FIG. 20A.

FIGS. 22A to 22C are views showing an amplitude distribution in the main scanning direction (B) and the sub-scanning direction (C) in an aperture corresponding to a light shielding wall provided in the diaphragm of FIG. 20A.

FIGS. 23A to 23E are views showing an amplitude distribution in the main scanning direction (B) and the sub-scanning direction (C) or an intensity distribution in the main scanning direction (D) and the sub-scanning direction (E) when the diaphragm of FIG. 20A is used.

FIGS. 24A to 24D are views showing a intensity distribution after an aperture passage (A) and (C) or a beam profile at an image plane (B) and (D) when the diaphragm of FIGS. 20A and 20C is used

### DETAILED DESCRIPTION OF EMBODIMENTS

Hereinafter, preferred embodiments of the present invention will be described with reference to the accompanying drawings.

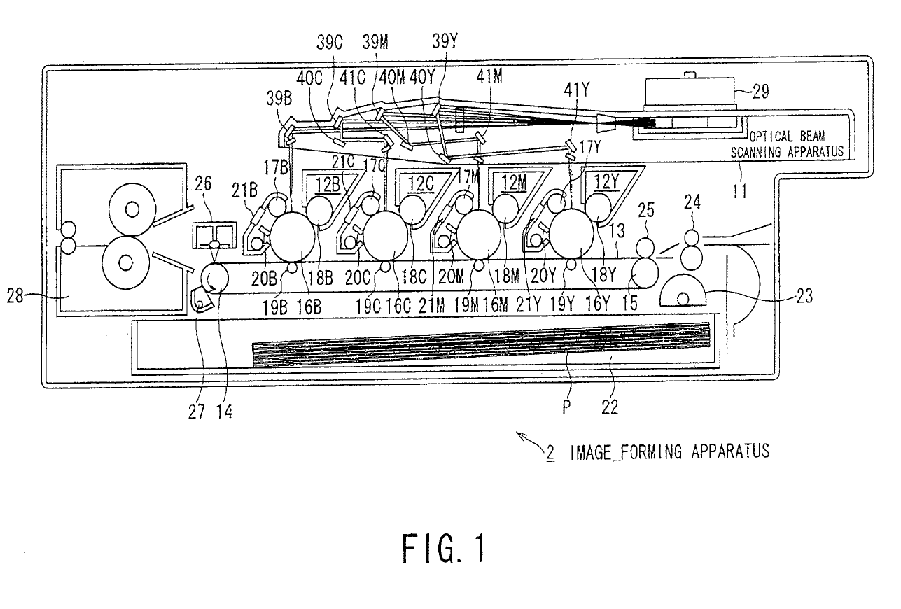

FIG. 1 shows a configuration of an image forming apparatus 1 equipped with an optical beam scanning apparatus 11 to which the present invention is applied.

Since the image forming apparatus 1 typically uses four kinds of image data separated for respective color component of Y (yellow), M (magenta), C (cyan) and B (black), and four sets of devices for forming an image for color component corresponding to each of Y, M, C and B, it identifies the image data for respective color data and the devices corresponding to respective color components by adding Y, M, C and B.

As shown in FIG. 1, the image forming apparatus 1 has first to fourth image forming parts 12Y, 12M, 12C and 12B for forming an image for each separated color component.

The image forming parts 12 (12Y, 12M, 12C and 12B) are arranged in order below the optical beam scanning apparatus 11 corresponding to each of positions at which laser beams L (LY, LM, LC and LB) for respective color components are emitted by a first post-deflection reflecting mirror 39B and third post-deflection reflecting mirrors 41Y, 41M and 41C of the optical beam scanning apparatus 11.

A carrying belt 13 for carrying a recording sheet P on which images formed through the respective image forming parts 12 (12Y, 12M, 12C and 12B) are transferred is arranged below the image forming parts 12 (12Y, 12M, 12C and 12B).

The carrying belt 13 is laid across a belt driving roller 14, which is rotated in a direction indicated by an arrow by a motor (not shown), and a tension roller 15, and is rotated at a predetermined speed in the rotation direction of the belt driving roller 14.

The image forming parts 12 (12Y, 12M, 12C and 12B) have respective photoconductive drums 16Y, 16M, 16C and 16B which have a cylindrical shape rotatable in a direction indicated by an arrow and on which electrostatic latent images corresponding to images exposed to light by the optical beam scanning apparatus 11 are formed. These photoconductive drums 16 are defined as “scanned object”.

Around the photoconductive drums 16 (16Y, 16M, 16C and 16B), electrifying devices 17 (17Y, 17M, 17C and 17B) for providing a predetermined potential to surfaces of the photoconductive drums 16 (16Y, 16M, 16C and 16B), developing devices 18 (18Y, 18M, 18C and 18B) for developing the electrostatic latent images formed on the surfaces of the photoconductive drums 16 (16Y, 16M, 16C and 16B) by supplying toner given with colors corresponding to the electrostatic latent images, transferring devices 19 (19Y, 19M, 19C and 19B) for transferring toner images of the photoconductive drums 16 (16Y, 16M, 16C and 16B) onto a recording medium, i.e., the recording sheet P, carried by the carrying belt 13, cleaners 20 (20Y, 20M, 20C and 20B) for removing toner remaining on the photoconductive drums 16 (16Y, 16M, 16C and 16B), and neutralizing devices 21 (21Y, 21M, 21C and 21B) for eliminating a potential remaining on the photoconductive drums 16 (16Y, 16M, 16C and 16B) after transfer of the toner images are arranged in order along a rotation direction of the photoconductive drums 16 (16Y, 16M, 16C and 16B).

The transferring devices 19 (19Y, 19M, 19C and 19B) face the photoconductive drums 16 (16Y, 16M, 16C and 16B) from the rear side of the carrying belt 13 with the carrying belt 13 interposed between the transferring devices 19 (19Y, 19M, 19C and 19B) and the photoconductive drums 16 (16Y, 16M, 16C and 16B).

A sheet cassette 22 for accommodating recording sheets P to be transferred with images formed by the image forming parts 12 (12Y, 12M, 12C and 12B) is arranged below the carrying belt 13. In addition, the cleaners 20 (20Y, 20M, 20C and 20B) remove the toner remaining on the photoconductive drums 16 (16Y, 16M, 16C and 16B), which was not transferred in the transfer of the toner images onto the recording sheet P by the transferring devices 19 (19Y, 19M, 19C and 19B).

A crescent-shaped feeding roller 23 for drawing out the recording sheets P accommodated in the sheet cassette 22, one by one, from the top of the sheet cassette 22 is arranged at one end of the sheet cassette 22 and near the tension roller 15.

A registration roller 24 for registering a leading end of one recording sheet P drawn out of the cassette 22 with a leading end of a toner image formed on the photoconductive drums 16B of the image forming part 12B (black) is disposed between the feeding roller 23 and the tension roller 15.

An absorption roller 25 for providing a predetermined electrostatic absorbing force to one recording sheet P carried by the registration roller 24 at a predetermined timing is disposed near the tension roller 15 between the registration roller 24 and the first image forming part 12Y and at a position which is substantially opposite to an outer side of the carrying belt 13 and corresponds to a position at which the tension roller 15 contacts the carrying belt 13.

A first registration sensor 26a and a second registration sensor 26b for detecting positions of images formed on the carrying belt 13 or images transferred onto the recording sheets P are disposed at one end of the carrying belt 13, near the belt driving roller 14 and on the outer side of the carrying belt 13 substantially contacting the belt driving roller 14, with a predetermined distance between both sensors in an axial direction of the belt driving roller 14 (since FIG. 1 is a front sectional view, the first registration sensor 26a located in front of a face of paper is not seen).

A carrying belt cleaner 27 for removing toner attached to the carrying belt 13 or small fragments of the recording sheets P is disposed on the outer side of the carrying belt 13 contacting the belt driving roller 14 and at a position at which the carrying belt cleaner 27 does not contact with the recording sheet P carried by the carrying belt 13.

A fixation device 28 for fixing the toner images, which were transferred onto the recording sheets P, on the recording sheets P is disposed in a direction in which the recording sheets P carried through the carrying belt 13 are cast off from the belt driving roller 14 and are further carried to.

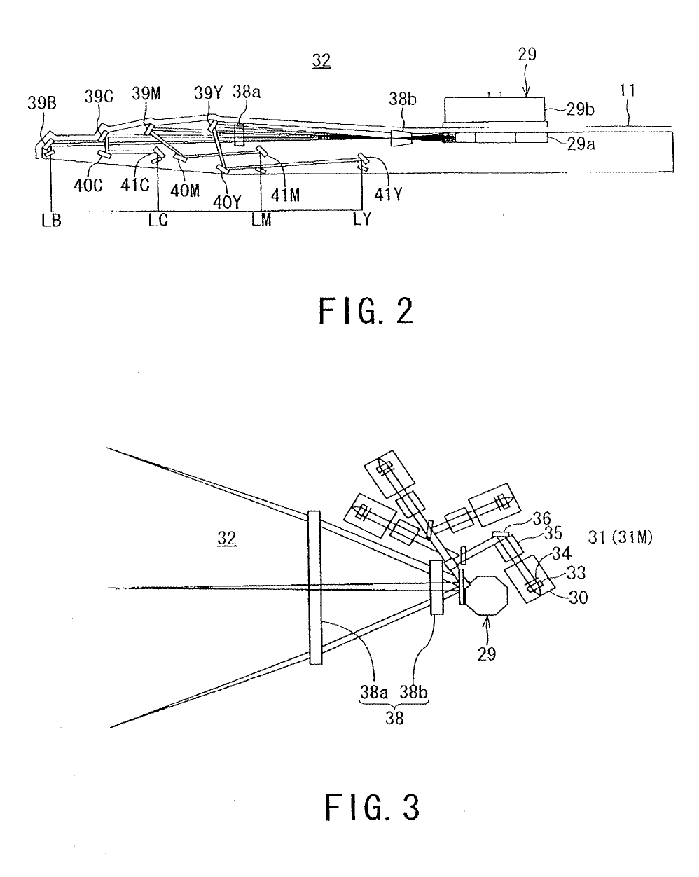

FIGS. 2 and 3 show a detailed configuration of the optical beam scanning apparatus 11 shown in FIG. 1.

The optical beam scanning apparatus 11 has an optical beam deflecting device 29 including a polygonal mirror body (so-called polygon mirror) 29a having, for example, 8-plane reflecting surfaces (plane reflecting mirrors) and a motor 29b for rotating the polygonal mirror body 29a at a predetermined speed in a main scanning direction, and light sources (LD array) 30 (30Y, 30M, 30C and 30B) for emitting light beams to the first to fourth image forming parts 12Y, 12M, 12C and 12B shown in FIG. 1, respectively.

The optical beam deflecting device 29 is a deflecting means for deflecting (scanning) light beams (laser beams), which are emitted from the light sources 30 (30Y, 30M, 30C and 30B), to image planes disposed at predetermined positions (that is, outer sides of the photoconductive drums 16Y, 16M, 16C and 16B of the first to fourth image forming parts 12Y, 12M, 12C and 12B) at a predetermined linear speed. In addition, pre-deflection optical systems 31 (31Y, 31M, 31C and 31B) are disposed between the optical beam deflecting device 29 and the light sources 30 (30Y, 30M, 30C and 30B) and a post-deflection optical system 32 is disposed between the optical beam deflecting device 29 and the image planes.

A direction in which the laser beams are deflected (scanned) by the polygon mirror (the polygonal mirror body 29a shown in FIG. 3) (a rotational axial direction of the photoconductive drums 16) is defined as “main scanning direction” and a direction which is perpendicular to the optical axial direction of the optical system and the main scanning direction is defined as “sub-scanning direction”. Accordingly, the sub-scanning direction is the rotational direction of the photoconductive drums 16. In addition, “image plane” indicates the outer side of the photoconductive drums 16 and “imaging plane” indicates a plane on which a light flux (laser beam) is actually imaged.

As shown in FIG. 3, the pre-deflection optical systems 31 include the light sources 30 (30Y, 30M, 30C and 30B) for respective color components, such as laser diodes, finite focusing lenses 33 (33Y, 33M, 33C and 33B) for condensing the laser beams emitted from the light sources 30 (30Y, 30M, 30C and 30B), diaphragms (apertures) 34 (34Y, 34M, 34C and 34B) for giving any section beam shape to the laser beams L that passed the finite focusing lenses 33 (33Y, 33M, 33C and 33B), and cylindrical lenses 35 (35Y, 35M, 35C and 35B) for again condensing the laser beams passed the diaphragms 34 (34Y, 34M, 34C and 34B) in the sub-scanning direction, and directs the laser beams emitted from the light sources 30 (30Y, 30M, 30C and 30B) and having a predetermined section beam shape to a reflecting surface of the optical beam deflecting device 29.

A cyan laser beam LC emitted from the cylindrical lens 35C is bent in its optical path by a reflecting mirror 36C, passes through an optical path combining optical part 37, and then is guided to the reflecting surface of the optical beam deflecting device 29. A black laser beam LB emitted from the cylindrical lens 35B is bent in its optical path by a reflecting mirror 36B, reflected by the optical path combining optical part 37, and then is guided to the reflecting surface of the optical beam deflecting device 29. A yellow laser beam LY emitted from the cylindrical lens 35Y passes over the reflecting mirror 36C, passes through the optical path combining optical part 37, and then is guided to the reflecting surface of the optical beam deflecting device 29. A magenta laser beam LM emitted from the cylindrical lens 35M is bent in its optical path by a reflecting mirror 36M, passes over the reflecting mirror 36B, reflected by the optical path combining optical part 37, and then is guided to the reflecting surface of the optical beam deflecting device 29.

The post-deflection optical system 32 includes two fθ lens 38 (38a and 38b) as image lenses for optimizing shape and position of the laser beams L (Y, M, C and B), which are deflected (scanned) by the polygonal mirror body 29a, on the image planes, a horizontal synchronization sensor (not shown) for detecting the laser beams L in order to align horizontal synchronization of the laser beams L (LY, LM, LC and LB) passed the fθ lenses 38 (38a and 38b), a horizontal synchronization reflecting mirror (not shown) for reflecting the laser beams L toward the horizontal synchronization sensor, and a separation mirror (not shown) disposed between the horizontal synchronization reflecting mirror and the horizontal synchronization sensor for approximately matching the laser beams L (LY, LM, LC and LB) for respective color components, which were reflected toward the horizontal synchronization sensor by the horizontal synchronization reflecting mirror, to an incident position on a detection surface of the horizontal synchronization sensor, a horizontal synchronization slit plate for passing the laser beams to the horizontal synchronization sensor, and a plurality of post-deflection reflecting mirrors 39Y, 40Y and 41Y (yellow); 39M, 40M and 41M (magenta); 39C, 40C and 41C (cyan); and 39B (black) for directing the laser beams L (LY, LM, LC and LB) for respective color components, which were emitted from the fO lenses 38 (38a and 38b), to corresponding photoconductive drums 16 (16Y, 16M, 16C and 16B).

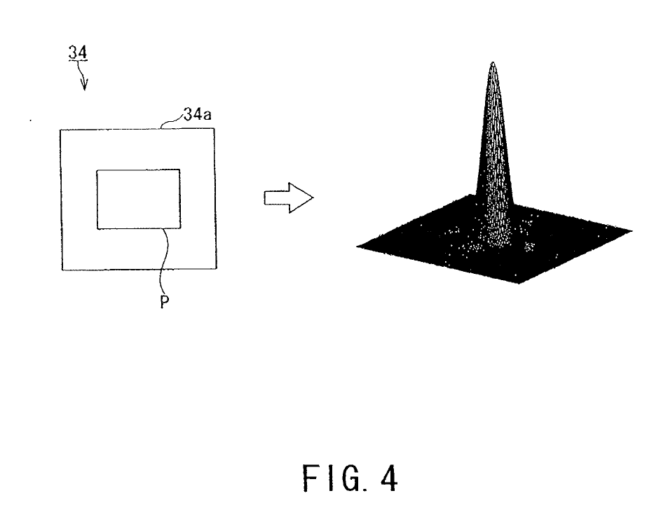

In general, between the light source 30 and the polygonal mirror body (polygon mirror) 29a is arranged a diaphragm (aperture part) 34 to allow a laser beam, which passed through the finite focus lens (collimator lens) 33, to have any beam sectional shape. When laser light (laser beam) having a uniform energy distribution passes through a rectangular aperture P of the diaphragm (aperture part) 34, a beam profile at an image plane on which an image is formed by an imaging optical system may have a sidelobe occurring in the main scanning direction and the sub-scanning direction (directions perpendicular to each side of the rectangular aperture), as shown in FIG. 4, for example. In addition, the aperture P of the diaphragm (aperture part) 34 is provided in a plate 34a constituting the diaphragm 34.

In the related art, there has been known a technique of suppressing a height of a sidelobe (flare) by diversifying directions of a sidelobe (flare) occurring in a beam profile using a polygonal or circular aperture provided in the diaphragm 34 (for example, see Patent Document 1 (JP-A-2005-266258)).

In addition, there has been also known a technique in which a partial light shielding member for shielding only a luminous flux of a laser beam which passes an annular region which is separated by a predetermined distance in the radial direction from the center axis of the beam with a light shielding part is arranged on an optical path of the laser beam between a laser light source and a polygon mirror (for example, see Patent Document 2(JP-A-2004-191929)).

However, in the technique disclosed in Patent Document 1, although this technique reduces the amount (height) of flare by diversifying directions of occurrence of flare, since the amount of integration in the main scanning direction presents an effect in the scanning optical system, a flare diversified in a non-scanning direction is likely to have an adverse effect.

In addition, in the technique disclosed in Patent Document 2, the incident luminous flux is partially shielded by the light shielding member and then is further shielded by an aperture diaphragm. However, since a shape of a laser beam intensity distribution or a height of a sidelobe on an image plane greatly depends on a positional relationship between the partial light shielding member and the aperture diaphragm and the partial light shielding member is a member different from the aperture diaphragm, the height of the sidelobe is significantly affected by an error of positioning.

Like this, it is difficult to sufficiently reduce a sidelobe (or its height) occurring in a beam profile on an image plane when an image is formed on the image plane by an imaging optical system.

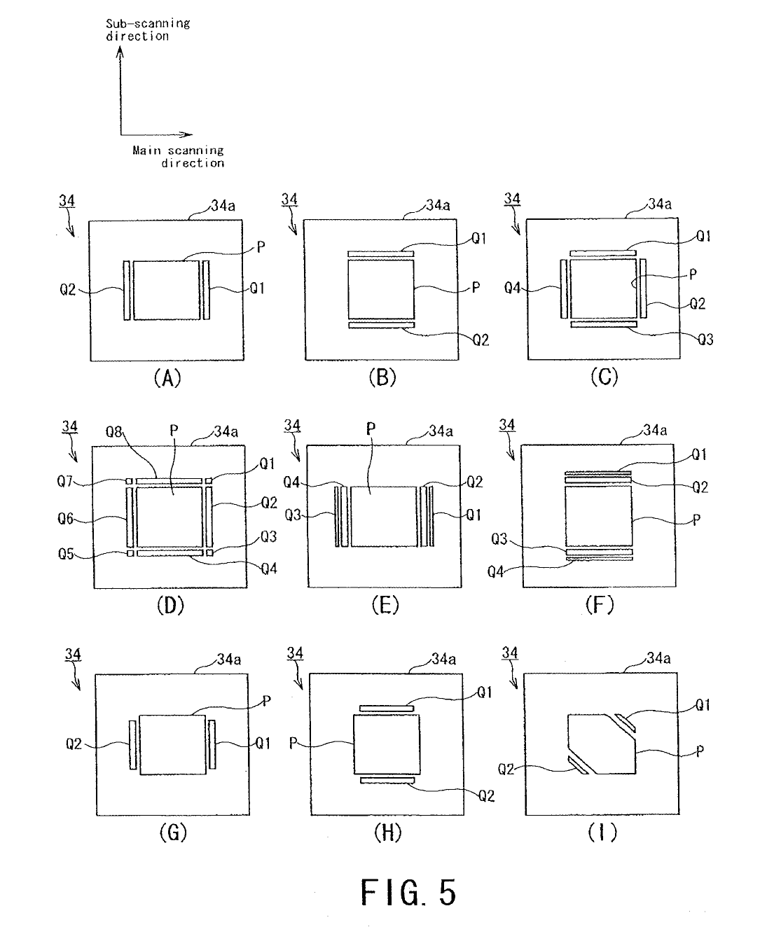

To avoid such difficulty, in the present invention, it is configured that a sidelobe having the highest peak of sidelobes occurring in a beam profile is reduced by a shape of the aperture. For example, as shown in FIGS. 5A to 5H, at least one aperture Q, which is separated from the aperture P, is provided at both sides or one side of the aperture P through which a main light beam of the laser beam emitted from the light source 30 passes. In other words, at least one light shielding wall (pillar) separating the aperture P from the aperture Q is provided at both sides or one side of the aperture P in the main scanning direction.

More specifically, in FIG. 5A, two apertures Q₁ and Q₂, which are separated from the aperture P, are respectively provided at both sides in the main scanning direction of the aperture P through which the main light beam of the laser beam emitted from the light source 30 passes. In FIG. 5B, two apertures Q₁ and Q₂, which are separated from the aperture P, are respectively provided at both sides in the sub-scanning direction of the aperture P through which the main light beam of the laser beam emitted from the light source 30 passes. In FIG. 5C, apertures Q (Q₁ to Q₄), which are separated from the aperture P, are provided at both sides in the main scanning direction and both sides in the sub-scanning direction of the aperture P through which the main light beam of the laser beam emitted from the light source 30 passes. FIG. 5D is similar to FIG. 5C.

In FIG. 5E, a plurality of apertures, which are separated from the aperture P, are respectively provided at both sides in the main scanning direction of the aperture P through which the main light beam of the laser beam emitted from the light source 30 passes. In FIG. 5F, a plurality of apertures, which are separated from the aperture P, are respectively provided at both sides in the sub-scanning direction of the aperture P. In FIG. 5G, apertures Q₁ and Q₂, which are separated from the aperture P, are respectively provided at both sides in the main scanning direction of the aperture P through which the main light beam of the laser beam emitted from the light source 30 passes, with the longitudinal dimension of the apertures Q₁ and Q₂ different from (smaller than) the longitudinal dimension of the aperture P through which the main light beam passes. In FIG. 5H, apertures Q₁ and Q₂, which are separated from the aperture P, are respectively provided at both sides in the sub-scanning direction of the aperture P through which the main light beam of the laser beam emitted from the light source 30 passes, with the longitudinal dimension of the apertures Q₁ and Q₂ different from (smaller than) the longitudinal dimension of the aperture P through which the main light beam passes.

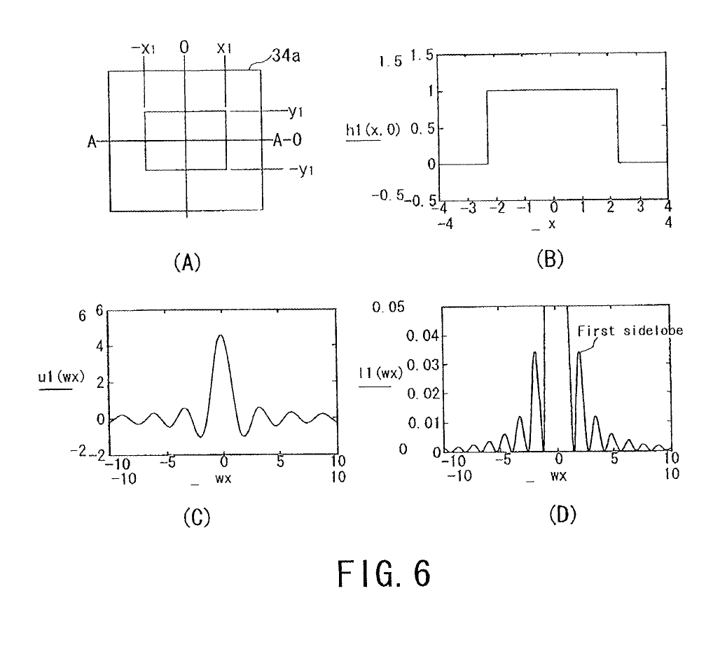

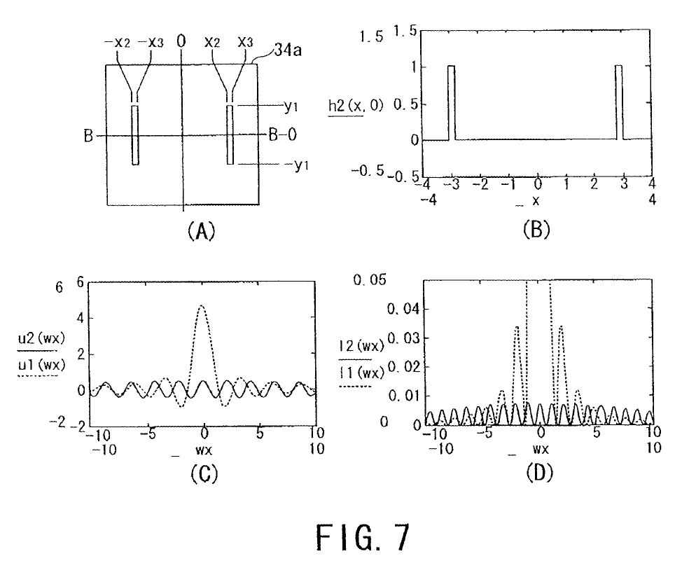

Here, the effect of the invention when the diaphragm (aperture part) 34 having the shape of aperture shown in FIG. 5A is used will be described in detail. For the diaphragm 34 of FIG. 5A, it can be considered that the aperture provided in the diaphragm 34 is a combination of the main aperture P through which the main light beam passes and the apertures Q₁ and Q₂ which are separated from the aperture P. The aperture P is indicated by a region of |x|≦x₁∩|y|≦y₁, as shown in FIG. 6A. The apertures Q₁ and Q₂ are indicated by a region of x₂≦|x≦|x₃∩|y|≦y₁, as shown in FIG. 7A.

First, the main aperture P will be considered. Although the laser beam that passes through the aperture P has naturally an intensity distribution (Gaussian distribution), an one-dimensional model (FIG. 6B) that passes through a section on line A-A of FIG. 6A, for example, will be considered for the sake of brevity. In the aspect that an amplitude distribution at an image plane when light having a uniform energy distribution passes through the aperture P which is rectangular may be obtained by subjecting an aperture function (pupil function) to Fourier transformation, an energy distribution shown in FIG. 6B becomes an amplitude distribution shown in FIG. 6C. An intensity distribution of the main light beam becomes an intensity distribution shown in FIG. 6D. The present invention aims at reduction of height of a first sidelobe shown in FIG. 6D.

Next, apertures Q₁ and Q₂ as two slits will be considered. Like the aperture P, an one-dimensional model (FIG. 7B) that passes through a section on line B-B of FIG. 7A, for example, will be considered for the sake of brevity. For example, an energy distribution shown in FIG. 7B becomes an amplitude distribution shown in FIG. 7C. An intensity distribution of the light that passes through the apertures Q₁ and Q₂ becomes an intensity distribution shown in FIG. 7D.

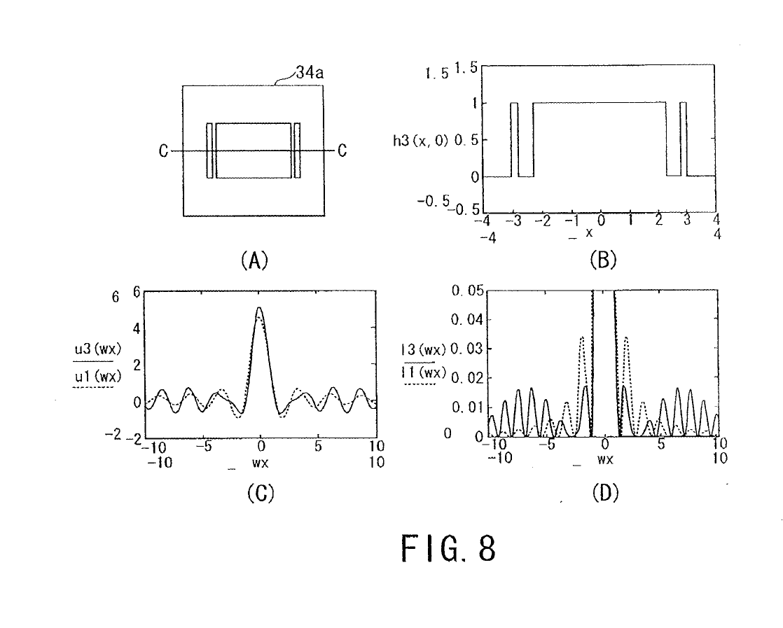

Then, the apertures provided in the diaphragm 34 of FIG. 5A will be considered with reference to FIGS. 8A to 8D. Here, an one-dimensional model (FIG. 8B) that passes through a section on line C-C of FIG. 8A, for example, will be considered for the sake of brevity. For example, an energy distribution shown in FIG. 8B becomes a superimposition of an amplitude distribution (waveform) shown in FIG. 6C and an amplitude distribution (waveform) shown in FIG. 7C and becomes an amplitude distribution shown in FIG. 8C. An intensity distribution of the light that passes through the apertures provided in the diaphragm 34 of FIG. 5A becomes an intensity distribution shown in FIG. 8D.

Here, the amplitude distributions (waveforms) shown in FIGS. 6C and 7C can control sites to be strengthened or weakened in an amplitude distribution synthesized by setting of parameters x₁, x₂ and x₃. For example, it is possible to sufficiently lower the height of the first sidelobe, however, height of other sidelobes (second sidelobe and below) may become reflexly raised. On this account, a parameter set to make the height of the first sidelobe as the first peak equal to the height of other sidelobes which become reflexly raised becomes the optimal solution. For example, as shown in FIG. 8D, the height of the first sidelobe as the first peak may be lowered to less than half of the original height indicated by a dotted line (a solid line indicates an intensity distribution when the apertures provided in the diaphragm 34 of FIG. 5A are used, and the dotted line indicates an intensity distribution when a rectangular aperture is used).

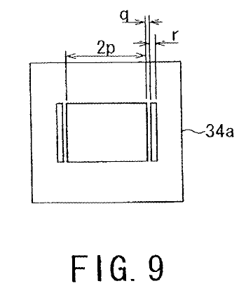

Thus, a relationship between parameters of the apertures provided in the diaphragm 34 of FIG. 5A will be obtained as below. As shown in FIG. 9, it is assumed that width of a main slit (main aperture) is 2p (p=x₁), width in the main scanning direction of a light shielding wall separating the main slit from two slits (apertures other than the main aperture) is q (=x₂−x₁), and width in the main scanning direction of the two slits is r (=x₃−x₂).

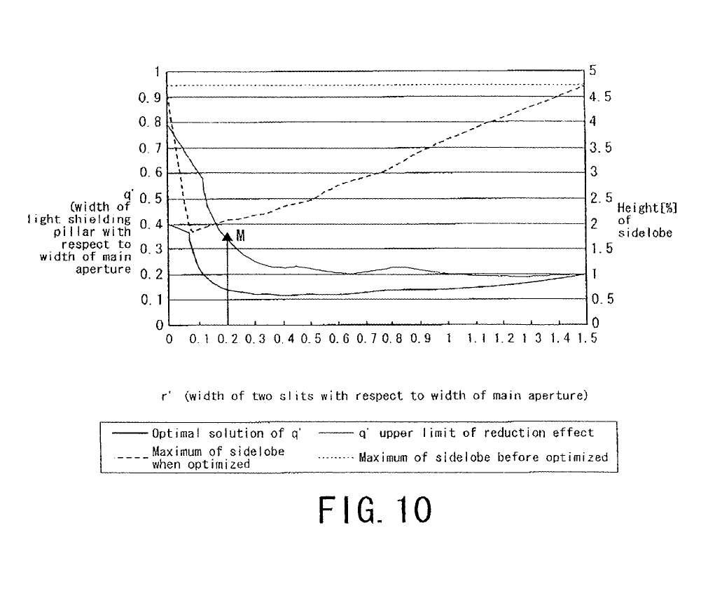

In case where light incident on the apertures is uniform parallel light, if a ratio expression p:q:r is same rate, sidelobes have the equal height although beam diameters are different from each other. For the sake of simplicity of a ratio relationship, the ratio expression is divided by p to be changed to a modified ratio expression 1: (q/p):(r/p), and then a final ratio expression 1: q′:r′ is obtained with (q/p)=q′ and (r/p)=r′. Then, a relationship between q′ and r′ of two silt apertures to make it possible to reduce the maximum (about 4.72%:100% of mainlobe) of sidelobe height of the main slit having sectional width 2 (2×1) is obtained. This relationship between q′ and r′ is shown in a graph of FIG. 10.

In the graph of FIG. 10, a horizontal axis represents r′, a left vertical axis represents q′, and a right vertical axis represents the maximum [%] of sidelobe height. Values expressed as “the optimal solution of q′” by a thick solid line are a plot of q′ at which the maximum of sidelobe height becomes minimal for r′, and a plot of the maximum of sidelobe height at the time is “maximal sidelobe when optimized” of a thick dotted line. In the graph of FIG. 10, when r′ is about 0.08, the maximum of sidelobe height becomes minimal. At this time, the ratio expression p:q:r=1:0.289:0.08. When the maximum (%) of mainlobe height is 100%, a range of r′ to obtain a reduction effect is between about 0 and 1.5 in that the maximum (%) of sidelobe height before optimized is 4.72%, as can be seen from the graph of FIG. 10.

Similarly, a plot of the upper limit of the reduction effect at each r′ is “upper limit of q′ of reduction effect” indicated by a thin solid line. The thin solid line means that when q′ for each r′ is beyond this upper limit, the maximum of sidelobe height exceeds 4.72%. In other words, when q′ for each r′ is larger than 0, the reduction effect can be obtained to some extent.

In this manner, when q′ for each r′ is larger than 0 and is set to a value smaller than the limit of the reduction effect, it is possible to obtain an effect of reducing the height of sidelobe. Also, q′ to be the optimal solution in the range is present.

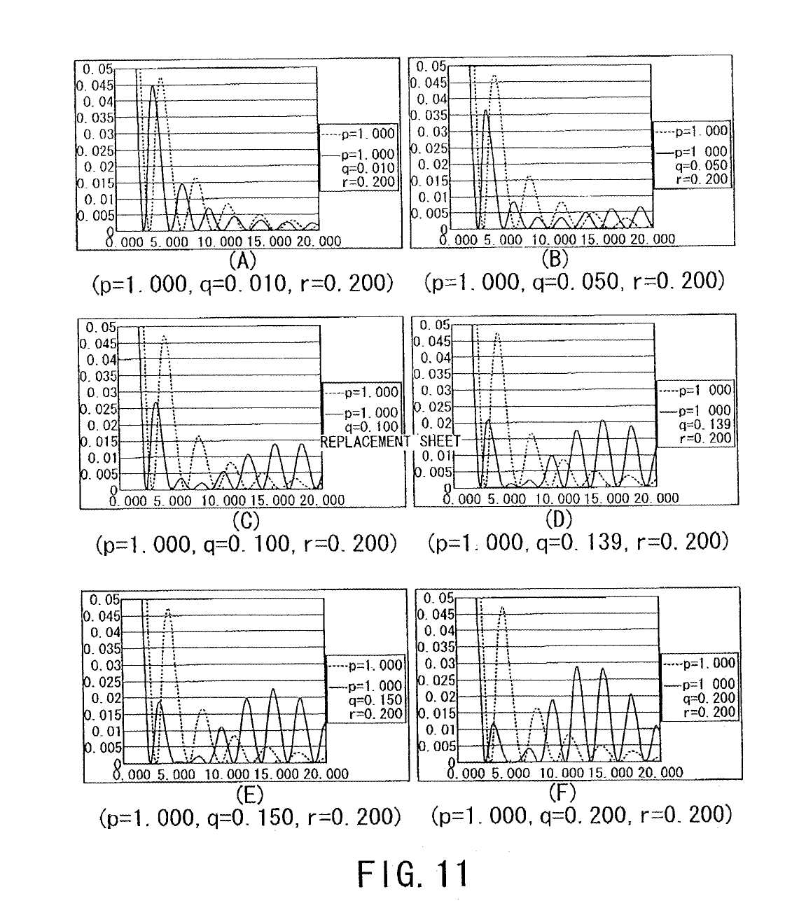

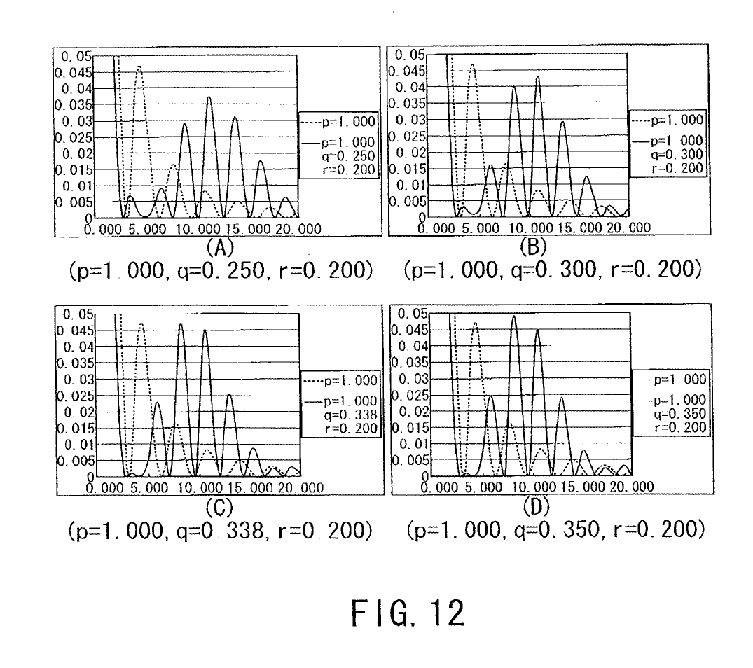

FIGS. 11A to 11F and 12A to 12D show change of a beam profile when q′ is 0.01, 0.05, 0.10, 0.139, 0.15, 0.20, 0.25, 0.30, 0.338 and 0.35 for r′=0.2. Here, a value of q′ is assigned in a direction of an arrow M of FIG. 10.

Solid lines in FIGS. 11A to 11F and 12A to 12D represent beam profiles when the apertures (p:q:r=1:q′:0.20) provided in the diaphragm 34 of FIG. 5A is used, and dotted lines in FIGS. 11A to 11F and 12A to 12D represent beam profiles when an underlying rectangular aperture (p=1) is used. As a value of q′ slowly increases from q′=0.01, the maximum of sidelobe height decreases and becomes minimal at q′=0.139 (optimal solution) (that is, the height of first sidelobe balances the height of subsequent sidelobes). However, when a value of q′ exceeds 0.139 (optimal solution), the maximum of sidelobe height increases and becomes substantially equal to that of the underlying rectangular aperture at q′=0.338 (reduction upper limit). At q′=0.35, the maximum of sidelobe height exceeds the maximum of sidelobe height of the underlying rectangular aperture.

In addition, as shown in FIGS. 8A to 8D, in comparison of the original rectangular aperture with the apertures (p:q:r=1:q′:0.20) provided in the diaphragm 34 of FIG. 5A, respective beam diameters are different from each other. On this account, in order to obtain the same beam diameter as the rectangular aperture before application of the present invention, there is a need to modify respective values with the ratio expression for p, q and r unchanged.

Next, “optimal solution of q′” indicated by the thick solid lines in FIG. 10 is expressed by approximate equations. When q′ for the optimal solution is assumed to be q_{bs}′ (r′), it is expressed by the following approximate equations in the following four intervals. That is, (1) in an interval of 0<(r′)<0.065, an approximate equation q_{ba}′(r′)=3.97501*10⁻¹−4.91525*10⁻¹*(r′), and (2) in an interval of 0.065<(r′)≦0.4, an approximate equation q_{bs}′(r′)=1.35423−2.91965*10⁺¹*(r′)+3.05995*10⁺²*(r′)²−1.72576*10⁺³*(r′)³+5.39006*10⁺³*(r′)⁴−8.75443*10⁺³*(r′)⁵+5.75944*10⁺³*(r′)⁶.

(3) in an interval of 0.4<(r′)≦0.9, an approximate equation q_{ba}′(r′)=8.97540−9.24426*10⁺¹*(r′)+3.93761*10⁺²*(r′)²−8.75924*10⁺²*(r′)³+1.07314*10⁺³*(r′)⁴−6.86667*10⁺²*(r′)⁵+1.79402*10⁺²*(r′)⁶, and (4) in an interval of 0.9<(r′)≦1.5, an approximate equation q_{bs}′(r′)=2.78127*10⁻¹−1.75687*10⁻¹*(r′)−4.90437*10⁻¹*(r′)²+1.16371*(r′)³−9.48435*10⁻¹*(r′)⁴+3.66083*10⁻¹*(r′)⁵−5.44427*10⁻²*(r′)⁶.

To sum up using the above equations, assuming that width of the maim slit is 2p, width of the light shielding wall separating the main slit from two slits is q, and width of two slits is r, p:q:r=1:(q/p):(r/p)=1:q′:r′, and the condition to make the maximum of sidelobe height minimal is the condition of q′=(q/p)=q_{bs}′(r′)=q_{bs}′(r/p). Accordingly, a ratio between parameters p, q and r of optimal apertures becomes p:q:r=1:q_{bs}′(r′):r′ or p:q:r=1:q_{bs}′(r/p):r/p.

Similarly, “upper limit of q′ of reduction effect” indicated by the thin solid lines in FIG. 10 is expressed by approximate equations. When q′ of upper limit of reduction effect is assumed to be qᵤₗ′(r′), it is expressed by the following approximate equations in the following four intervals. That is, (1) in an interval of 0<(r′)≦0.0119, an approximate equation qᵤₗ′(r′)=7.89720*10⁻¹−1.79006*(r′), and (2) in an interval of 0.0119<(r′)≦0.4, an approximate equation qᵤₗ′(r′)=9.57574−2.26428*10⁺²*(r′)+2.31179*10⁺³*(r′)²−1.24123*10⁺⁴*(r′)³+3.66783*10⁺⁴*(r′)⁴−5.64763*10⁺⁴*(r′)⁵+3.54185*10⁺⁴*(r′)⁶.

(3) in an interval of 0.4<(r′)≦0.9, an approximate equation qᵤₗ′(r′)=−6.54032+5.94073*10⁺¹*(r′)−2.12936*10⁺²*(r′)²+4.03321*10⁺²*(r′)³−4.31916*10⁺²*(r′)⁴+2.51123*10⁺²*(r′)⁵−6.23974*10⁺¹*(r′)⁶, and (4) in an interval of 0.9<(r′)≦1.5, an approximate equation qᵤₗ′(r′)=3.56251−1.37982*10⁺¹*(r′)³+2.45383*10⁺¹*(r′)²−2.41558*10⁺¹(r′)³+1.37333*10⁺¹*(r′)⁴−4.23113*(r′)⁵+5.49038*10⁻¹*(r′)⁶.

To sum up using the above equations, assuming that width of the maim slit is 2p, width of the light shielding wall separating the main slit from two slits is q, and width of two slits is r, p:q:r=1:(q/p):(r/p)=1:q′:r′, and a range for reduction of the maximum of sidelobe height is a range of 0<q′<qᵤₗ′(r′) or 0<(q/p)<qᵤₗ′(r/p).

Although it has been hitherto illustrated that the separate rectangular apertures having the same width in the sub (main) scanning direction are arranged at both sides in the main (sub) scanning direction of the apertures provided in the diaphragm 34 of FIG. 5A, that is, the rectangular apertures through which the main light beam passes, it is to be understood that the number of separate apertures may increase to more than two, as shown in FIGS. 5E and 5F. In addition, as shown in FIGS. 5G and 5H, widths in the sub (main) scanning direction of the apertures may be different from each other.

In the mean time, in practicing the present invention, it can be considered that a pressing work for metal plate or a photoetching work for the metal plate is employed to form an aperture in the plate 34a as an aperture member. As width of the slit (aperture) and the light shielding wall grows smaller and smaller, it becomes more difficult to perform the pressing work for the plate 34a, but the photoetching work is still possible. The working limit of the photoetching work depends on the thickness of the plate 34a.

As described above, the ratio of p:q:r to make the maximum of sidelobe height minimal is 1:0.289:0.08. On the contrary, the aperture working limit of the photoetching is about 0.8T (T is thickness). Accordingly, when the thickness of the plate 34a is 0.1 mm and the width of the main slit is 2 mm (2p), it is possible to obtain a light shielding wall having width of 0.289 mm and a slit having width of 0.08 mm. This is one example of the ratio, but it is possible to work the aperture with the ratio if the width of the main slit is more than at least 2 mm. In consideration of availability, workability and strength of a metal plate, the most useful thickness of the plate 34a is 0.1 mm. Of course, even when the width of the main slit is less than 2 mm, the plate 34a having thickness of less than 0.1 mm may be used as long as it has a sufficient strength.

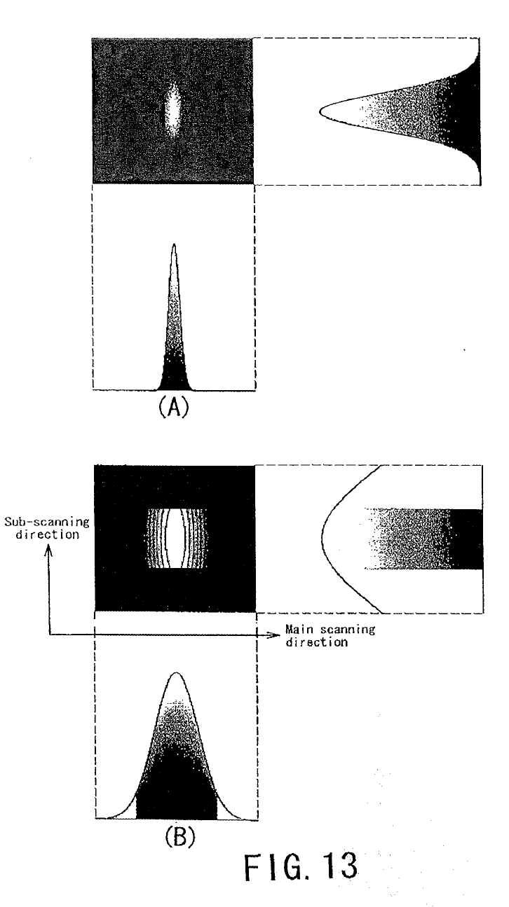

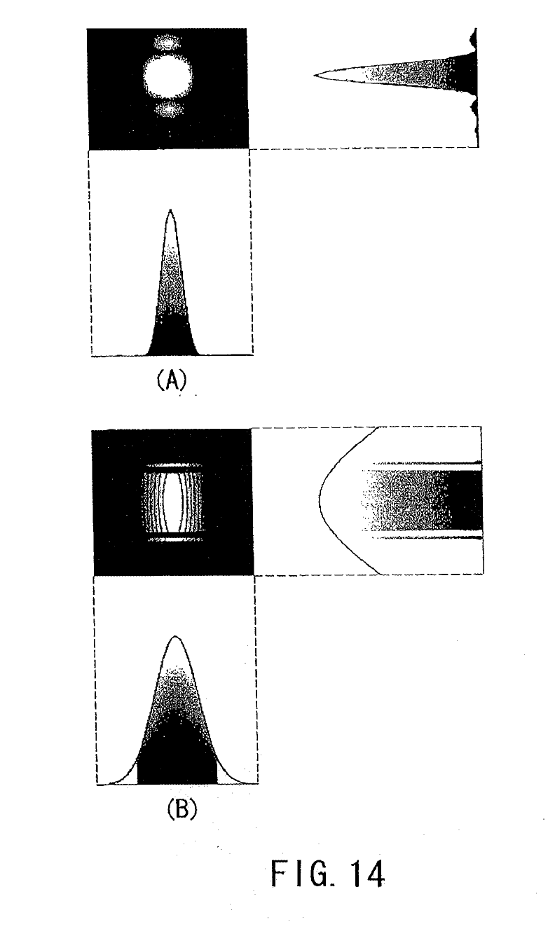

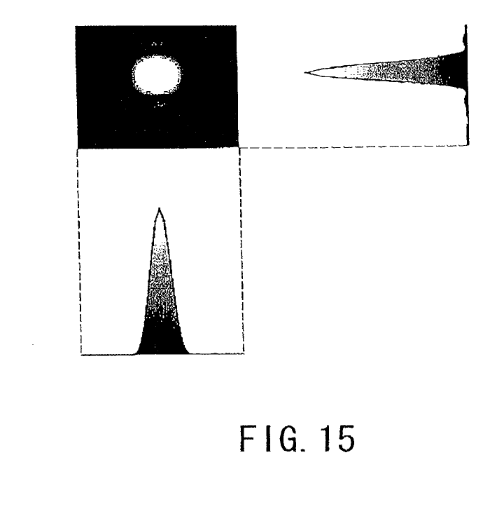

In an application to an actual scanning optical system, the main current is to use a semiconductor laser as the light source 30. Although a strength distribution of the semiconductor laser is a Gaussian distribution, a radiation angle (divergence angle) in a horizontal direction is different from that in a vertical direction, as shown in FIG. 13A, for example. A light beam emitted from the semiconductor laser is changed to parallel light by a finite focus lens (collimator lens), with the ratio of the radiation angle unchanged, and is directed to the apertures of the diaphragm 34. Depending on an optical system, for example, as shown in FIG. 13B, it may be considered that a direction having a smaller radiation angle is the main (sub) scanning direction and a direction having a larger radiation angle is the sub (main) scanning direction. In this case, since the main (sub) scanning direction has less vignetting due to the apertures (that is, close to a Gaussian distribution), the height of sidelobe becomes smaller. On the other hand, since the sub (main) scanning direction has more vignetting due to the apertures, that is, is close to the uniform energy distribution, as described above, the height of sidelobe becomes larger, as shown in FIG. 14A, for example. In this case, for example, using the diaphragm 34 of FIG. 5B, a slit to reduce a sidelobe may be provided in a direction in which the sidelobe occurs, as shown in FIG. 14B, for example. FIG. 15 shows an effect after application of the diaphragm 34 of FIG. 5B.

In this manner, in the present invention, it is possible to realize reduction of sidelobes in the apertures formed in the plate 34a (plate member) of low costs. Accordingly, it is possible to properly reduce the sidelobes occurring in a beam profile.

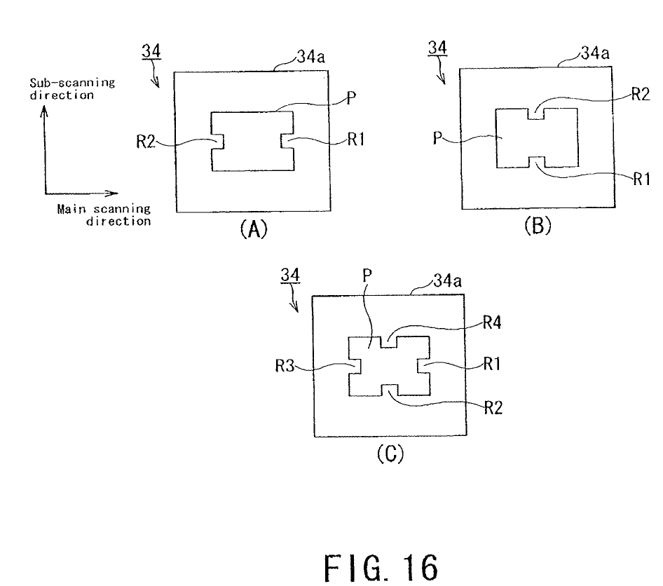

At least one aperture Q, which is separated from the aperture P, has been provided at both sides or one side of the aperture P through which the main light beam of the laser beam emitted from the light source 30 passes, as shown in FIGS. 5A to 5H, for example, but the present invention is not limited to this. For example, as shown in FIGS. 16A to 16C, light shielding walls to cover a portion of the aperture P from about the center of the edge of the light shielding wall at both sides or one side of the aperture P to the center of the aperture P may be provided. Specifically, for example, in FIG. 16A, light shielding walls R₁ and R₂ to cover a portion of the aperture P from about the center of the edge of the light shielding wall at both sides in the main scanning direction of the aperture P to the center of the aperture P are provided. In FIG. 16B, light shielding walls R₁ and R₂ to cover a portion of the aperture P from about the center of the edge of the light shielding wall at both sides in the sub-scanning direction of the aperture P to the center of the aperture P are provided. In FIG. 16C, light shielding walls R₁ to R₄ to cover a portion of the aperture P from about the center of the edge of the light shielding wall at both sides in the main scanning direction and sub-scanning direction of the aperture P to the center of the aperture P are provided.

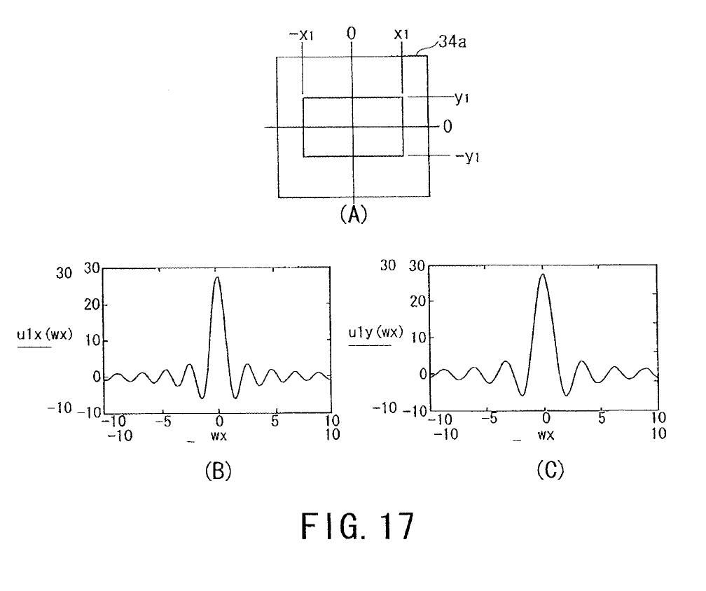

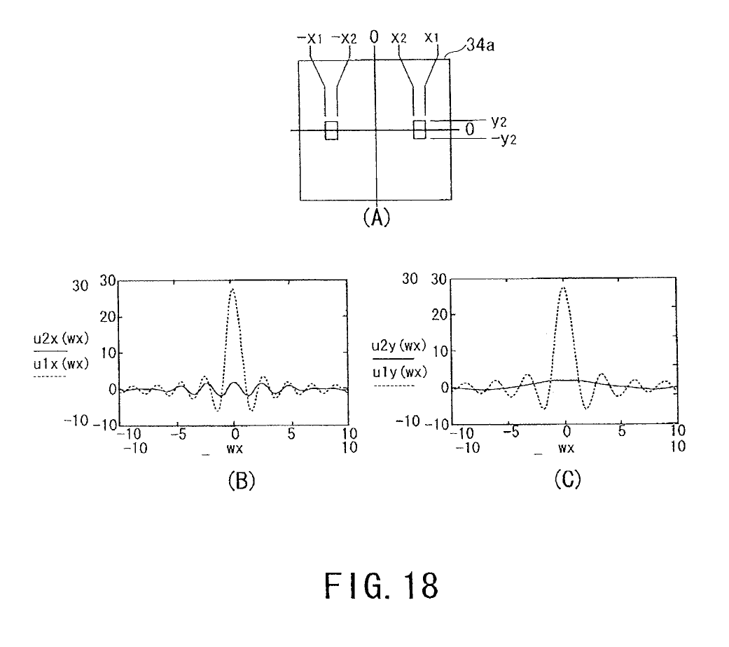

The effect of the invention when the diaphragm (aperture part) 34 having the shape of aperture shown in FIG. 16A is used will be described in detail. For the diaphragm 34 of FIG. 16A, it can be considered that the aperture provided in the diaphragm 34 is an exclusion of other apertures R₁ and R₂ from the main aperture P through which the main light beam passes. The aperture P is indicated by a region of |x|≦x₁∩|y|≦y₁, as shown in FIG. 17A, for example. The apertures (slits) R₁ and R₂ excluded from the aperture P are indicated by a region of x₂≦|x|≦x₁∩|y|≦y₂, as shown in FIG. 18A.

While the aperture is indicated by the region of |x|≦x₁∩|y|≦y₁ in FIG. 17A, an amplitude distribution of a section of the aperture in the main scanning direction is shown in FIG. 17B and an amplitude distribution of a section of the aperture in the sub-scanning direction is shown in FIG. 17C. While two slits are indicated by the region of x₂≦|x|≦x₁∩|y|≦y₂ in FIG. 18A, an amplitude distribution of a section of the slits in the main scanning direction is shown in FIG. 18B and an amplitude distribution of a section of the slits in the sub-scanning direction is shown in FIG. 18C.

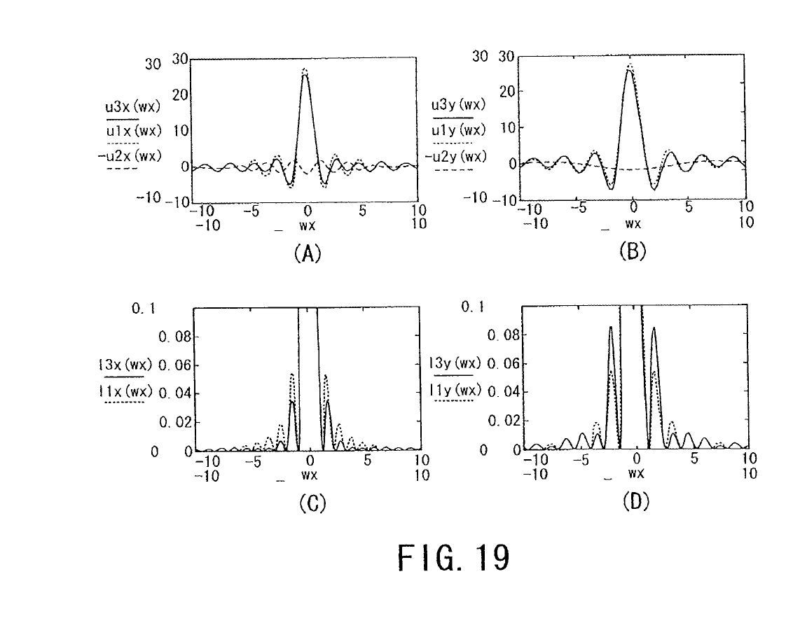

Since the aperture of FIG. 16A has a shape to shield an aperture portion of FIG. 18A from the aperture of FIG. 17A, the amplitude distribution of the aperture of FIG. 16A may be a superimposition of an inversed (sign-inversed) amplitude shown in FIGS. 18B and 18C on the amplitude distribution shown in FIGS. 17B and 17C. Accordingly, the amplitude distribution of the section of the aperture in the main scanning direction of FIG. 16A becomes an amplitude distribution shown in FIG. 19A, and the amplitude distribution of the section of the aperture in the sub-scanning direction becomes an amplitude distribution shown in FIG. 19B. An intensity distribution of the section of the aperture in the main scanning direction of FIG. 16A becomes an intensity distribution shown in FIG. 19C, and an intensity distribution of the section of the aperture in the sub-scanning direction becomes an intensity distribution shown in FIG. 19D.

As can be seen from FIG. 18B, since a phase of the amplitude distribution of the main aperture indicated by a dotted line is close to a phase of the amplitude distribution of two slits and the amplitude of two slits are actually inversed, the height of sidelobe tends to be suppressed in a global range. Unlike the aperture of the diaphragm 34 shown in FIGS. 5A to 5H, there are fewer sites to more strengthen the amplitude. However, as shown in FIG. 18C, other perpendicular direction is affected and thus the height of sidelobe slightly increases in the other direction. On this account, as shown in FIG. 14A, it is preferable that the aperture is used when sidelobe in the other direction (in this case, the sub-scanning direction) is sufficiently small.

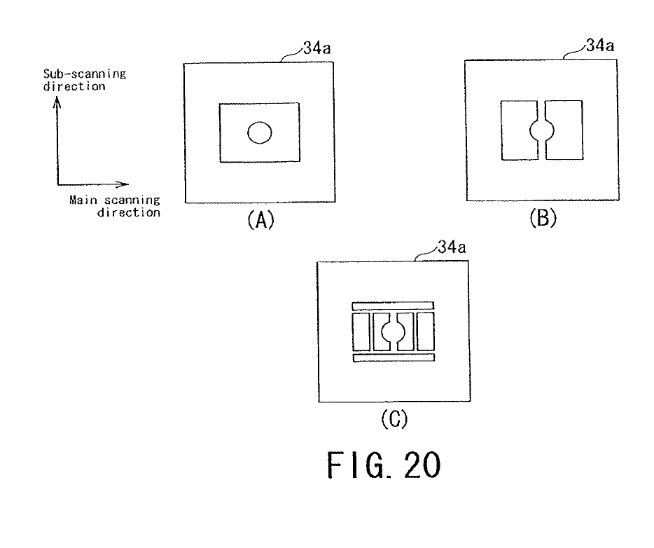

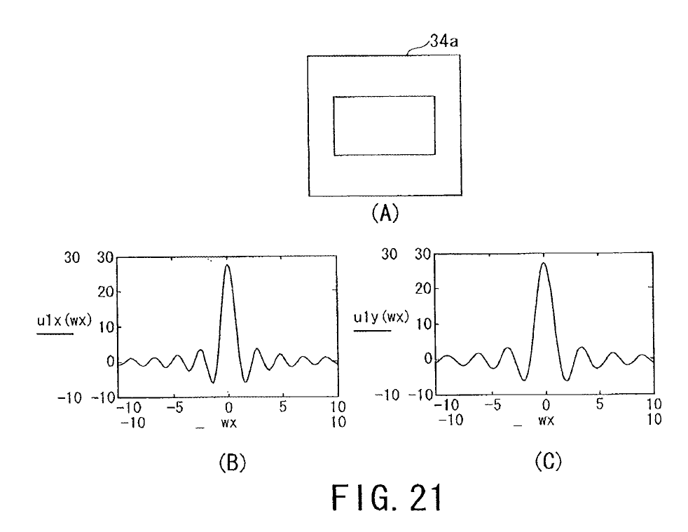

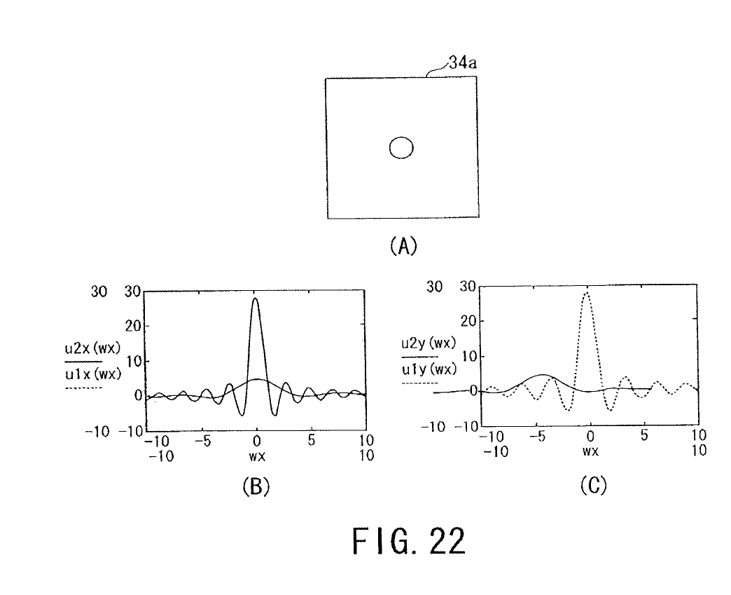

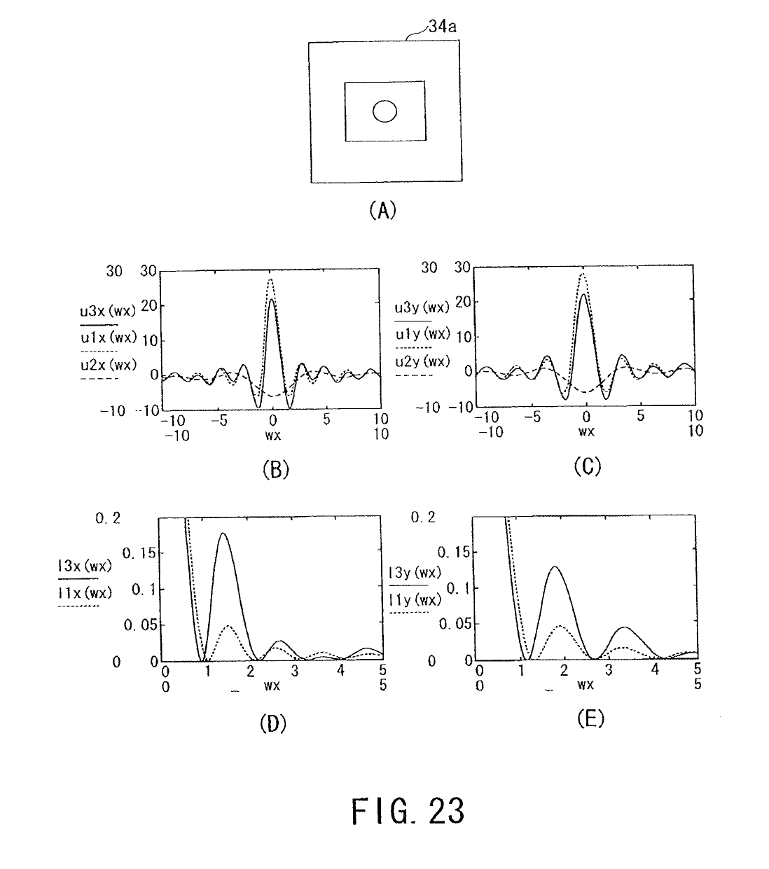

As shown in FIGS. 20A to 20C, when a light shielding wall to cover a portion of the main aperture is provided in about the center of the aperture, it is possible to make a beam diameter small. But, this causes an adverse effect of increase of sidelobe. Then, in this case, a method of reducing the sidelobes is used in combination. The aperture of FIG. 20A has a shape to shield a circular aperture shown in FIG. 22, for example, from a rectangular aperture shown in FIG. 21. Like the apertures described with reference to FIGS. 16 to 19, the amplitude distribution of the aperture of FIG. 20A may be a superimposition of an inversed (sign-inversed) amplitude distribution of the circular aperture (a main scanning section amplitude distribution at an image plane is shown in FIG. 22B and a sub-scanning section amplitude distribution is shown in FIG. 22C) on the amplitude distribution of the rectangular aperture (a main scanning section amplitude distribution at an image plane is shown in FIG. 21B and a sub-scanning section amplitude distribution is shown in FIG. 21C). As a result, the amplitude distribution of the section in the main scanning direction of the aperture of FIG. 20A becomes an amplitude distribution shown in FIG. 23B (a solid line indicates a combined aperture, a dotted line indicates the rectangular aperture and a dashed line indicates an inverse of the circular aperture), and the amplitude distribution of the section in the sub-scanning direction of the aperture becomes an amplitude distribution shown in FIG. 23C (a solid line indicates a combined aperture, a dotted line indicates the rectangular aperture and a dashed line indicates an inverse of the circular aperture).

FIG. 23D is an enlarged view of an intensity distribution of a main scanning section of the aperture of FIG. 20A and FIG. 23E is an enlarged view of an intensity distribution of a sub-scanning section of the aperture. In FIGS. 23D and 23E, a solid line indicates an intensity distribution when the aperture of FIG. 20A is used, and a dotted line indicates an intensity distribution when the original rectangular aperture is used. This makes it possible to decrease a beam diameter. But this may also cause a problem of increase of sidelobe.

Although the shape of the aperture of FIG. 20A can not be realized by one sheet of metal plate, it may be realized by a combination of a typical aperture with a printing for the center of parallel flat glass (not shown) which is prepared in pre-deflection optical systems 31 in advance and a printing for the center of the cylinder lens 35 or the finite focus lens (collimator lens) 33 which exist in pre-deflection optical systems 31. In addition, when the aperture is prepared by plate, it may be realized by a combination of the main aperture with a portion of the light shielding wall as shown in FIG. 20B. In this case, with application of the aperture of FIGS. 16A to 16C, when a separate light shielding wall to connect both sides or one side at an edge of the light shielding wall in a certain direction having a (particularly large) sidelobe to the center of the light shielding wall is provided, it is possible to suppress a sidelobe from being increased due to make a beam diameter small.

In addition, as shown in FIG. 20C, it is possible to use the sidelobe reduction effect of the aperture of FIGS. 5A to 5H by providing one or more sub apertures (in the sub-scanning direction in FIG. 20C) or providing one or more light shielding walls to separate apertures from each other (in the main scanning direction in FIG. 20C).

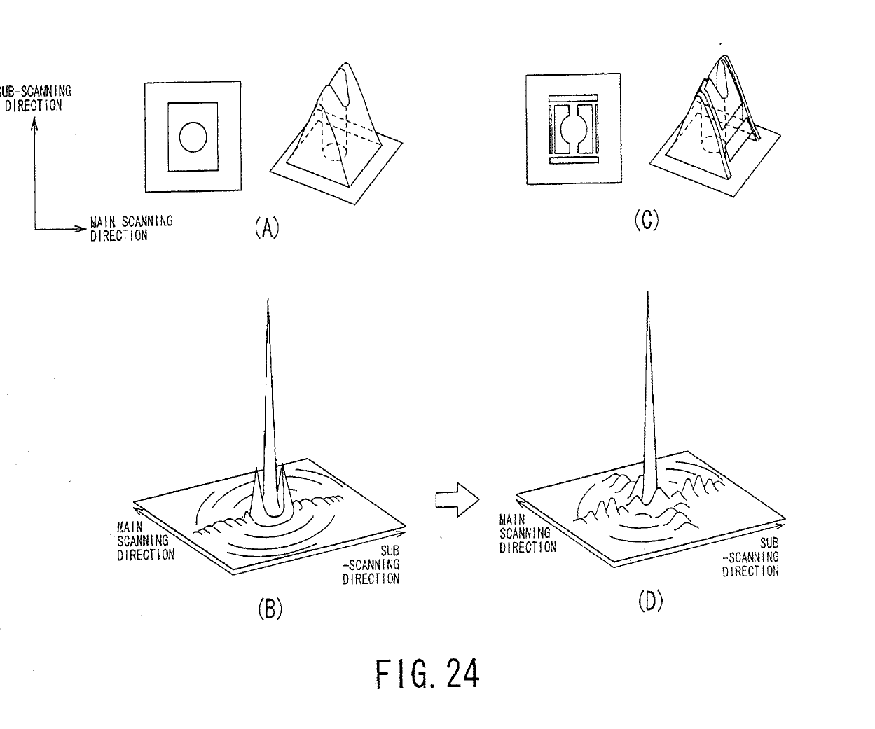

Here, FIG. 24B is a view showing a beam profile at an image plane when the light beam (one part in which width of the light beam is narrower is set in the main scanning direction, and the other part in which width of the light beam is broader is set in the sub-scanning direction) having actual Gaussian distribution passes through the aperture of FIG. 20A. Notably, FIG. 24A shows a distribution of the light beam after passes through the aperture of FIG. 20A.

As shown in FIG. 20B, this makes it possible to make a beam diameter small, but this may also cause a problem of increase of sidelobe. Then, in this case, a method of reducing the sidelobes as shown in FIG. 20C is used in order to prevent increase of sidelobe. FIG. 24D shows a beam profile at an image plane when the light beam having actual Gaussian distribution passes through the aperture of FIG. 20C, and FIG. 24C shows a distribution of the light beam after passes through the aperture of FIG. 20C. Accordingly, it is possible to reduce height of sidelobes in the sub-scanning direction, although sidelobes slightly occur in the main scanning direction.

In FIG. 5A to 5H, although at least one aperture (second aperture) separated from the aperture P (first aperture) is provided at one or both sides of the aperture P in one or more of the main scanning direction and sub-direction, the present inventions is not limited thereto and various modifications are possible.

In FIG. 5A to 5H, square apertures are used. However, the aperture P formed by cutting off two opposite corners of a square as shown in FIG. 5I can also be used. In this case, the sidelobe occurs in an oblique direction to the main scanning direction and sub-scanning direction, so that second apertures Q₁ and Q₂ may be provided in the oblique direction in FIG. 5I.

1. An optical beam scanning apparatus comprising:
a light source configured to emit one or plural light fluxes;
an optical beam deflecting device configured to deflect the light flux, which is emitted from the light source, to a scanned object in a main scanning direction; and
an aperture part provided between the light source and the optical beam deflecting device,
wherein the aperture part includes a first aperture through which a main light beam of the light flux emitted from the light source passes, and at least one second aperture which is different from the first aperture and is provided at outer circumference of the first aperture and through which a part of the light flux passes.

2. The optical beam scanning apparatus according to claim 1, wherein the at least one second aperture is provided at both sides or one side in one or more of the main scanning direction and a sub-scanning direction of the first aperture.

3. The optical beam scanning apparatus according to claim 1, wherein the at least one second aperture is provided at both sides or one side in the main scanning direction and a sub-scanning direction of the first aperture.

4. The optical beam scanning apparatus according to claim 1, wherein a plurality of second apertures is provided at both sides or one side in one or more of the main scanning direction and a sub-scanning direction of the first aperture.

5. The optical beam scanning apparatus according to claim 1, wherein the at least one second aperture is provided in a direction in which sidelobe occurs in the first aperture through which the main light beam of the light flux emitted from the light source passes.

6. The optical beam scanning apparatus according to claim 1, wherein the first aperture and the second aperture are entirely surrounded by the light flux incident on a light shielding part that shields the light flux emitted from the light source.

7. The optical beam scanning apparatus according to claim 1, wherein the first aperture and the second aperture are formed on the same plate.

8. The optical beam scanning apparatus according to claim 1, wherein the first aperture and the second aperture have a rectangular shape.

9. The optical beam scanning apparatus according to claim 8, wherein, assuming that width of a section in a direction in which the second aperture provided at both sides of the first aperture is present is 2p, width of a light shielding wall separating the first aperture from the second aperture provided at both sides of the first aperture is q, and width of the second aperture is r, when a ratio of p:q:r is normalized to a ratio of 1:(q/p):(r/p)=1:q′:r′, p, q and r satisfy a relational equation of p:q:r=1:q_{bs}′(r′):r′, where q_{bs}′(r′) is defined by the following equations: (1) for 0<(r′)≦0.065, q_{bs}′(r′)=3.97501*10⁻¹−4.91525*10⁻¹*(r′), and (2) for 0.065<(r′)≦0.4, q_{bs}′(r′)=1.35423−2.91965*10⁺¹*(r′)+3.05995*10⁺²*(r′)²−1.72576*10⁺³*(r′)³+5.39006*10⁺³*(r′)⁴−8.75443*10⁺³*(r′)⁵+5.75944*10⁺³*(r′)⁶, (3) for 0.4<(r′)≦0.9, q_{bs}′(r′)=8.97540−9.24426*10⁺¹*(r′)+3.93761*10⁺²*(r′)²−8.75924*10⁺²*(r′)³+1.07314*10⁺³*(r′)⁴−6.86667*10⁺²*(r′)⁵+1.79402*10⁺²*(r′)⁶, and (4) for 0.9<(r′)≦1.5, q_{bs}′(r′)=2.78127*10⁻¹−1.75687*10⁻¹*(r′)−4.90437*10⁻¹*(r′)²+1.16371*(r′)³−9.48435*10⁻¹*(r′)⁴+3.66083*10⁻¹*(r′)⁵−5.44427*10⁻²*(r′)⁶.

10. The optical beam scanning apparatus according to claim 8, wherein, assuming that width of a section in a direction in which the second aperture provided at both sides of the first aperture is present is 2p, width of a light shielding wall separating the first aperture from the second aperture provided at both sides of the first aperture is q, and width of the second aperture is r, when a ratio of p:q:r is normalized to a ratio of 1:(q/p):(r/p)=1:q′:r′, p, q and r satisfy a relational equation of p:q:r=1:q′:r′ and 0<q′<qᵤₗ′(r′), where qᵤₗ′(r′) is defined by the following equations: (1) for 0<(r′)≦0.0119, qᵤₗ′(r′)=7.89720*10⁻¹−1.79006*(r′), (2) for 0.0119<(r′)≦0.4, qᵤₗ′(r′)=9.57574−2.26428*10⁺²*(r′)+2.31179*10⁺³*(r′)²−1.24123*10⁺⁴*(r′)³+3.66783*10⁺⁴*(r′)⁴−5.64763*10⁺⁴*(r′)⁵+3.54185*10⁺⁴*(r′)⁶, (3) for 0.4<(r′)≦0.9, qᵤₗ′(r′)=−6.54032+5.94073*10⁺¹*(r′)−2.12936*10⁺²*(r′)²+4.03321*10⁺²*(r′)³−4.31916*10⁺²*(r′)⁴+2.51123*10⁺²*(r′)⁵−6.23974*10⁺¹*(r′)⁶, and (4) for 0.9<(r′)≦1.5, qᵤₗ′(r′)=3.56251−1.37982*10⁺¹*(r′)+2.45383*10⁺¹*(r′)²−2.41558*10⁺¹(r′)³+1.37333*10⁺¹*(r′)⁴−4.23113*(r′)⁵+5.49038*10⁻¹*(r′)⁶.

11. The optical beam scanning apparatus according to claim 9, wherein a ratio relationship of p:q:r=1:0.289:0.08 is satisfied.

12. The optical beam scanning apparatus according to claim 9, wherein the first aperture and the second aperture are formed on a plate, and the plate is a board having thickness of less than 0.1 mm.

13. The optical beam scanning apparatus according to claim 1, wherein length in a direction of the second aperture which is perpendicular to direction in which the first aperture and the second aperture juxtaposed is different from length in a direction of the first aperture which is perpendicular to direction in which the first aperture and the second aperture juxtaposed.

14. An optical beam scanning apparatus comprising:
a light source configured to emit one or plural light fluxes;
an optical beam deflecting device configured to deflect the light flux, which is emitted from the light source, to a scanned object in a main scanning direction; and
an aperture part provided between the light source and the optical beam deflecting device,
wherein the aperture part includes an aperture through which a main light beam of the light flux emitted from the light source passes, a first light shielding wall forming the aperture, and a second light shielding wall to cover a portion of the aperture from a part of outer circumference of the first aperture to the center of the aperture.

15. The optical beam scanning apparatus according to claim 14, wherein the second light shielding wall is provided from about the center of an edge of the first light shielding wall at both sides or one side in one or more of the main scanning direction and a sub-scanning direction of the aperture to the center of the aperture.

16. The optical beam scanning apparatus according to claim 14, wherein the second light shielding wall is provided from about the center of the edge of the first light shielding wall at both sides or one side in the main scanning direction and the sub-scanning direction of the aperture to the center of the aperture.

17. The optical beam scanning apparatus according to claim 14, wherein the second light shielding wall is provided from about the center of the edge of the first light shielding wall to the center of the aperture in a direction in which sidelobe occurs in the aperture through which the main light beam of the light flux emitted from the light source passes.

18. An optical beam scanning apparatus comprising:
a light source configured to emit one or plural light fluxes;
an optical beam deflecting device configured to deflect the light flux, which is emitted from the light source, to a scanned object in a main scanning direction; and
an aperture part provided between the light source and the optical beam deflecting device,
wherein the aperture part includes a first aperture through which a main light beam of the light flux emitted from the light source passes, a first light shielding wall forming the first aperture, and a second light shielding wall to cover a portion of the first aperture in about the center of the first aperture.

19. The optical beam scanning apparatus according to claim 18, wherein the second light shielding wall is connected to the first light shielding wall.

20. The optical beam scanning apparatus according to claim 19, wherein the first light shielding wall and the second light shielding wall are interconnected by a light shielding wall directing from about the center of the edge of the light shielding wall at both sides or one side in one or more of the main scanning direction and a sub-scanning direction of the first aperture to the center of the first aperture.

21. The optical beam scanning apparatus according to claim 19, wherein the first light shielding wall and the second light shielding wall are interconnected by a light shielding wall directing from about the center of the edge of the light shielding wall to the center of the first aperture in a direction in which sidelobe occurs in the first aperture through which the main light beam of the light flux emitted from the light source passes.

22. The optical beam scanning apparatus according to claim 18, wherein at least one second aperture different from the first aperture is provided at both sides or one side in one or more of the main scanning direction and a sub-scanning direction of the first aperture.

23. The optical beam scanning apparatus according to claim 18, wherein at least one second aperture different from the first aperture is provided in a direction in which sidelobe occurs in the first aperture through which the main light beam of the light flux emitted from the light source passes.

24. The optical beam scanning apparatus according to claim 18, wherein at least one light shielding wall separating the first aperture is provided at both sides or one side in one or more of the main scanning direction and a sub-scanning direction of the first aperture.

25. The optical beam scanning apparatus according to claim 18, wherein at least one light shielding wall separating the first aperture is provided in a direction in which sidelobe occurs in the first aperture through which the main light beam of the light flux emitted from the light source passes.

26. An optical beam scanning apparatus comprising:
a light source configured to emit one or plural light fluxes;
an optical beam deflecting device configured to deflect the light flux, which is emitted from the light source, to a scanned object in a main scanning direction; and
an aperture part provided between the light source and the optical beam deflecting device,
wherein the aperture part includes an aperture through which a main light beam of the light flux emitted from the light source passes, and the light is blocked in a portion of about the center of parallel flat glass, in a portion of about the center of a cylinder lens, or in a portion of about the center of a collimator lens, which is provided in position corresponding to about the center of the aperture.

27. An image forming apparatus having an optical beam scanning apparatus,
wherein the optical beam scanning apparatus comprises:
a light source configured to emit one or plural light fluxes;
an optical beam deflecting device configured to deflect the light flux, which is emitted from the light source, to a scanned object in a main scanning direction; and
an aperture part provided between the light source and the optical beam deflecting device,
wherein the aperture part includes a first aperture through which a main light beam of the light flux emitted from the light source passes, and at least one second aperture which is different from the first aperture and is provided at outer circumference of the first aperture and through which a part of the light flux passes.

28. An image forming apparatus having an optical beam scanning apparatus,
wherein the optical beam scanning apparatus comprises:
a light source configured to emit one or plural light fluxes;
an optical beam deflecting device configured to deflect the light flux, which is emitted from the light source, to a scanned object in a main scanning direction; and
an aperture part provided between the light source and the optical beam deflecting device,
wherein the aperture part includes an aperture through which a main light beam of the light flux emitted from the light source passes, a first light shielding wall forming the aperture, and a second light shielding wall to cover a portion of the aperture from a part of outer circumference of the first aperture to the center of the aperture.

29. An image forming apparatus having an optical beam scanning apparatus,
wherein the optical beam scanning apparatus comprises:
a light source configured to emit one or plural light fluxes;
an optical beam deflecting device configured to deflect the light flux, which is emitted from the light source, to a scanned object in a main scanning direction; and
an aperture part provided between the light source and the optical beam deflecting device, and
wherein the aperture part includes a first aperture through which a main light beam of the light flux emitted from the light source passes, a first light shielding wall forming the first aperture, and a second light shielding wall to cover a portion of the first aperture in about the center of the first aperture.

30. An image forming apparatus having an optical beam scanning apparatus,
wherein the optical beam scanning apparatus comprises: a light source configured to emit one or plural light fluxes;
an optical beam deflecting device configured to deflect the light flux, which is emitted from the light source, to a scanned object in a main scanning direction; and
an aperture part provided between the light source and the optical beam deflecting device,
wherein the aperture part includes an aperture through which a main light beam of the light flux emitted from the light source passes, and the light is blocked in a portion of about the center of parallel flat glass, in a portion of about the center of a cylinder lens, or in a portion of about the center of a collimator lens, which is provided in position corresponding to about the center of the aperture.
